(19) United States
(12) Patent Application Publication
(10) Pub. No.: US 2006/0033983 A1
(43) Pub. Date: Feb. 16, 2006

(54) Optical fiber for raman amplification

(76) Inventors: Guojun Dai, Monza (IT); Francesco Maria Tassone, Arcore (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/522,246

(22) PCT Filed: Jul. 26, 2002
(86) PCT No.: PCT/EP02/08383

§ 371 Date: Aug. 5, 2005

(51) Int. Cl. H01S 3/00

(52) U.S. Cl. 359/334

(57) ABSTRACT

Raman amplifier having an optical fiber made of a tellurite glass is disclosed. The tellurite glass has at least two further metal oxides, the metals of said respective two oxides being selected from a first group of Nb, W, Ti, Tl, Ta, and Mo and from a second group of Nb, W, Ti, Pb, Sb, In, Bi, Tl, Ta, Mo, Zr, Hf, Cd, Gd, La, and Ba. The so obtained fiber has improved optical (Raman gain) and/or thermal (thermal stability index) properties. Alternatively, the tellurite based glass compositions of the fiber have at least one additional metal oxide, where the metal is selected among Nb, Ti, Tl, Ta, and Mo, the glass showing a particularly high Raman gain. The maximum Raman gain of these glasses is typically higher than 100 times of the maximum Raman gain of pure silica and the respective total cross-section of the Raman spectrum is typically greater than 100 times the total cross-section of pure silica, in the frequency measurement range of 200 cm⁻¹ to 1080 cm⁻¹.

### FIELD OF THE INVENTION

The present invention relates to an optical fiber for Raman amplification and to a Raman amplifier comprising said optical fiber. In particular, said fiber is an optical fiber comprising a tellurite glass.

### BACKGROUND ART

To compensate attenuation, optical communication systems often provide for amplification of optical signals at regular intervals along optical transmission fibers. The amplification may be produced by amplifiers based on rare-earth elements such as erbium or by amplifiers based on the Raman effect.

Fiber Raman amplifiers are attracting great attention, because of their capability to increase the transmission capacity. Raman amplifiers offer several advantages, such as low noise, greater flexibility in choosing the signal wavelength and a flat and broad gain bandwidth. The greater flexibility in choosing the signal wavelength mainly depends on the fact that the Raman peak of a material, exploited for the amplification of the signal, is dependent practically only on the pump wavelength, differently from what happens for example in erbium-doped fiber amplifiers, in which the choice of the signal wavelength is restricted by the stimulated emission cross-section of erbium. The broad gain bandwidth of Raman amplifiers can be much enlarged, for example by using multiple pump sources. Such a broad gain bandwidth may represent a way to extend the usable optical bandwidth outside the conventional C-band and the extended L-band of the erbium-doped fiber amplifiers. Lumped Raman amplifiers may also play an important role to compensate for not only the fiber attenuation but also losses of other optical components, such as connectors, switches, splitters and so on.

While many glass compositions have been proposed in connection with erbium doped fiber amplifiers, little work has been done in developing glasses suitable for Raman amplification.

For instance, U.S. Pat. No. 6,352,950 discloses alkali-tungsten-tellurite glass compositions doped with a rare earth element, erbium in particular, capable of fluorescing when pumped with appropriate energy.

Similarly, International Patent Application WO 01/27047, also relating to erbium doped amplification, discloses erbium doped tellurite glasses including one or more oxides of the following elements: Ta, Nb, W, Ti, La, Zr, Hf, Y, Gd, Lu, Sc, Al and Ga.

On the other hand, dispersion compensating fibers (DCF) or, more generally, fibers having high non-linearity have been initially proposed for realizing fiber Raman amplifiers. For example, T. Tsuzaki et al., in “Broadband Discrete Fiber Raman Amplifier with High Differential Gain Operating Over 1.65 μm-band”, Optical Fiber Conference 2001 (MA3-1/3), describe a high differential-gain (0.08 dB/mW), low-noise (<5.0 dB), broadband (30 nm) and flat-gain (<+1 dB) fiber Raman amplifier operating over the 1.65 μm-band which employs a low-loss highly nonlinear fiber (HNLF) and a broadened pump light source.

European Patent Application EP 1 184 943 discloses a Raman amplifier including a chalcogenide glass optical fiber. As mentioned in said patent application, chalcogenide glasses are not oxide glasses.

JP patent application Publication No. 2001-109026 discloses a fiber Raman amplifier where the optical fiber is based on a tellurite (i.e. tellurium dioxide) glass, stating that with such fibers it is possible to obtain a gain coefficient about 30 times greater than the one obtained with quartz fibers. Said tellurite glass has a structure comprising TeO₂—ZnO-M₂O-L₂O₃, wherein M is one or more alkaline element, and L is at least one or more of Bi, La, Al, Ce, Yb and Lu. The applicant has however observed that the enhancement of the Raman gain correlated with these glass compositions is not completely satisfactory. In particular, both the maximum intensity and the total cross-sectional area of the Raman spectra of said tellurite glasses are less than one hundred times higher with respect to the corresponding parameters of pure silica glass. The above Japanese patent application further mentions that other tellurite glasses (for example TeO₂—WO₃) can be used for obtaining a high gain coefficient in Raman amplifiers, without however giving any detail about the composition and optical properties of said glasses.

As observed by the applicant, there is thus the need of developing further glass compositions to be used in optical fibers for Raman amplifiers.

### SUMMARY OF THE INVENTION

The Applicant has now found that tellurite glasses comprising at least two further metal oxides can be used to manufacture an optical fiber suitable for Raman amplification. In particular, the simultaneous presence of at least two different metal oxides in a tellurite based glass composition allows to optimise either the optical or the thermal properties (or both) of an optical fiber for Raman amplification, with respect to the same properties of the respective binary glass compositions of each of said oxides with tellurite. Among the optical properties of a glass for Raman amplification, particularly important are the maximum intensity of the emission peak and the broadness of the emission bandwidth. Among the thermal properties, particularly important is the thermal stability of the glass composition, as determined through the thermal stability index (Tx-Tg) of the glass. The thermal stability index is the difference between the crystallization temperature of the glass Tx, i.e. the temperature at the onset of crystal formation, and its glass transition temperature Tg. A good thermal stability of a glass is in general preferable for its processability; typically, the higher the value of the (Tx-Tg) index, the better the processability of the glass.

Furthermore, the Applicant has found tellurite based glass compositions including at least one additional metal oxide which show a particularly high Raman gain, and which are thus suitable for manufacturing optical fibers to be used in a Raman amplifier.

According to a first aspect, the present invention relates to a Raman amplifier comprising at least one optical fiber and at least one pump laser, optically coupled to said optical fiber, said pump laser being adapted for emitting a pump radiation at a wavelength λₚ, characterized in that said optical fiber comprises a tellurite glass suitable for enhancing Raman effect, said glass comprising:
from 50% to 90%, preferably from 65% to 85%, in mole percentage of TeO₂;
from 5% to 45%, preferably from 5% to 30%, more preferably from 10% to 25% in mole percentage of a first metal oxide of an element selected from the group consisting of: Nb, W, Ti, Tl, Ta, and Mo;
from 5% to 30%, preferably from 5% to 20% in mole percentage of a second different metal oxide of an element selected from the group consisting of: Nb, W, Ti, Pb, Sb, In, Bi, Tl, Ta, Mo, Zr, Hf Cd, Gd, La, Ba.

Preferably said first oxide is an oxide of an element selected from the group consisting of Nb, W and Ti. More preferably said oxide is a niobium or tungsten oxide.

Preferably, also said second different oxide is an oxide of an element selected from the group consisting of Nb, W and Ti.

According to a particularly preferred embodiment, said tellurite glass comprises from 50% to 90% in mole percentage of TeO₂, from 5% to 30% of niobium oxide and from 5% to 30% of tungsten oxide.

According to another aspect, the present invention relates to a Raman amplifier comprising at least one optical fiber and at least one pump laser, optically coupled to said optical fiber, said pump laser being adapted for emitting a pump radiation at a wavelength λₚ, characterized in that said optical fiber comprises a tellurite glass suitable for enhancing Raman effect, said glass comprising:
from 55% to 95%, preferably from 65% to 95%, in mole percentage of TeO₂;
from 5% to 45%, preferably from 5% to 35% in mole percentage of a metal oxide of an element selected from the group consisting of: Nb, Ti, Tl, Ta, and Mo.

A still further aspect of the invention relates to an optical telecommunication link including a optical fiber path for transmitting an optical signal and at least a Raman amplifier as above defined, optically coupled along said optical fiber path.

According to another aspect, the present invention relates to an optical fiber for Raman amplification comprising a glass composition which comprises:
from 50% to 90% in mole percentage of TeO₂;
from 5% to 45% in mole percentage of a first metal oxide of an element selected from the group consisting of: Nb, W, Ti, Tl, Ta, and Mo;
from 5% to 30% in mole percentage of a second different metal oxide of an element selected from the group consisting of: Nb, W, Ti, Pb, Sb, In, Bi, Tl, Ta, Mo, Zr, Hf Cd, Gd, La, Ba;
said composition being substantially free of erbium.

Preferably said first oxide is an oxide of an element selected from the group consisting of Nb, W and Ti. More preferably said oxide is a niobium or tungsten oxide.

Preferably, also said second different oxide is an oxide of an element selected from the group consisting of Nb, W and Ti.

According to a particularly preferred embodiment, said glass composition comprises from 50% to 90% in mole percentage of TeO₂, from 5% to 30% of niobium oxide and from 5% to 30% of tungsten oxide.

Preferably said tellurite glass shows a maximum Raman gain higher than 100 times, preferably higher than 120 times with respect to pure silica glass.

Preferably, the total cross-section of the Raman emission spectrum of said tellurite glass in the frequency shift range of from 200 cm⁻¹, to 1080 cm⁻¹ is at least 100 times greater with respect to the total cross-section of the Raman emission of pure silica in the same frequency shift range, more preferably at least 120 times greater, much more preferably 150 times greater.

Preferably said glass composition has a thermal stability index Tx-Tg higher than 125° C., more preferably higher than 150° C., even more preferably higher than 160° C.

According to a preferred aspect, said optical fiber comprises a core portion and a cladding portion, said core portion being made from a glass composition as above defined.

According to another aspect, the present invention relates to an optical fiber for Raman amplification comprising a glass composition which comprises:
from 55% to 95%, preferably from 65% to 95%, in mole percentage of TeO₂;
from 5% to 45%, preferably from 5% to 35% in mole percentage of a metal oxide of an element selected from the group consisting of: Nb, Ti, Tl, Ta, and Mo;
said composition being substantially free of erbium.

A still further aspect of the present invention relates to a method for increasing at least one of the parameters selected among Raman bandwidth broadening and thermal stability of a binary glass composition including tellurium oxide and a first metal oxide of an element selected among Nb, W, Ti, Tl, Ta, and Mo which comprises preparing a ternary glass composition comprising said tellurium oxide, said first metal oxide and a second different metal oxide of an element selected among Nb, W, Ti, Pb, Sb, In, Bi, Tl, Ta, Mo, Zr, Hf Cd, Gd, La, Ba.

### BRIEF DESCRIPTION OF THE DRAWINGS

FIG. 1 schematically shows an embodiment of a Raman amplifier according to the invention;

FIG. 2 shows an illustrative example of a Raman spectrum of a tellurite glass composition;

FIG. 3 shows a ternary diagram of a tellurite glass composition;

FIG. 4 shows the Differential scanning calorimetry diagram of three tellurite glass compositions;

FIG. 5 shows the Raman spectra of the same three tellurite glass compositions.

### DESCRIPTION OF THE INVENTION

As mentioned above, in the effort of providing glass compositions particularly suitable for the Raman amplification, the applicant has found that a tellurite glass comprising at least two different metal oxides can be advantageously used. In particular, said glass comprises:
from 50% to 90%, preferably from 65% to 85%, in mole percentage of TeO₂;
from 5% to 45%, preferably from 5% to 30%, more preferably from 10% to 25% in mole percentage of a first metal oxide of an element selected from the group consisting of: Nb, W, Ti, Tl, Ta, and Mo;
from 5% to 30%, preferably from 5% to 20% in mole percentage of a second different metal oxide of an element selected from the group consisting of: Nb, W, Ti, Pb, Sb, In, Bi, Tl, Ta, Mo, Zr, Hf, Cd, Gd, La, Ba.

In addition, the applicant has further found that a tellurite glass comprising:
from 55% to 95%, preferably from 65% to 95%, in mole percentage of TeO₂;
from 5% to 45%, preferably from 5% to 35% in mole percentage of a metal oxide of an element selected from the group consisting of: Nb, Ti, Pb, Tl, Ta, and Mo;
shows a relevant Raman gain, both in terms of peak intensity and of total Raman cross-section.

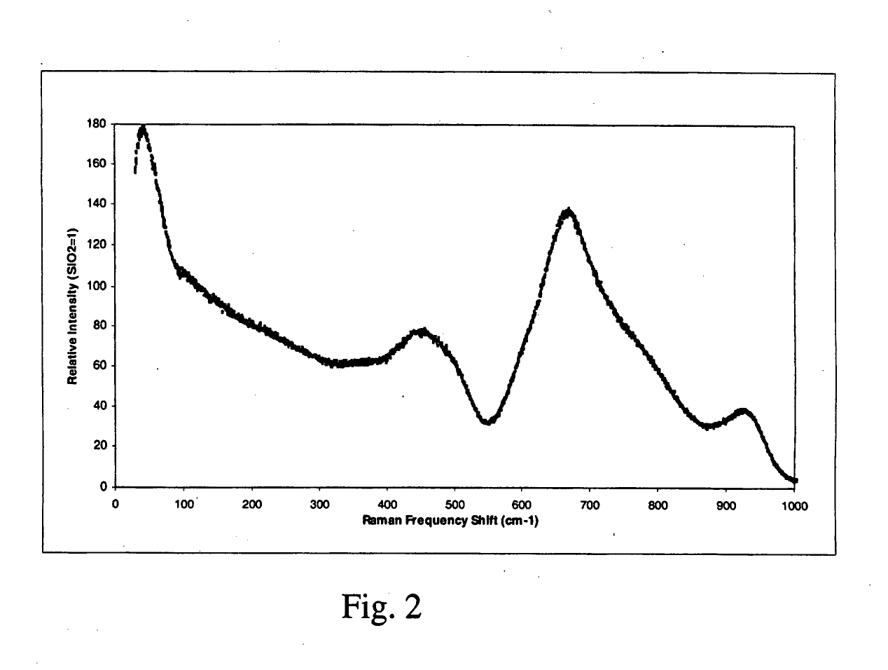

FIG. 2 shows an illustrative example of Raman spectrum of a glass composition for a fibre according to the invention.

Raman emission measurement has been performed on polished thin slabs of about 1 mm thickness and carried out in backscattering geometry, by using two different linearly polarized laser sources (a frequency doubled Nd:YAG laser operating at 532 nm, and a He—Ne laser operating at 633 nm). Details of the measurement methodology are given in the experimental part.

In order to make a quantitative analysis, the obtained Raman spectrum needs however to be corrected, due to the reduction of the solid angle of light collection and the reduction of the transmitted and collected power which occur at the air/glass interface. These corrections result into a multiplication factor:

$$F = \frac{{( 1 + {n}_{s} )}^{4}}{{( 1 + {n}_{Si} )}^{4}} \qquad ( 1 )$$

where nₛ and n_{Si} are the refraction index of the tellurite glass sample and of the silica glass reference, respectively, at the pump or signal wavelength. The index of refraction in the transparency region has been measured using an ellipsometer from 500 nm up to about 1700 nm. A well-polished, ultra-pure silica sample has been employed as a reference.

The correction factor F has been found to be substantially constant (variation of less than 1%) for the whole frequency range of Raman spectra.

The Raman gain of the tellurite glass with respect to pure silica at each frequency (i.e. the relative corrected intensity emission) can be determined by the following:
I_{corr}=F·I/I_{Si} (2)
where I is the intensity of Raman emission of the tellurite glass measured at a said frequency and I_{Si} is the maximum intensity of Raman emission of the reference silica glass, which occurs at the frequency of about 440 cm⁻¹. The Raman emission spectrum of the tellurite glass, corrected with respect to the Raman emission spectrum of pure silica, is obtained by plotting the calculated values of the I_{corr} parameter over the measured frequency range. The maximum Raman gain of a tellurite glass (Iₘₐₓ) with respect to silica glass is the gain I_{corr} measured in correspondence with the frequency of the maximum Raman emission peak of the tellurite glass (generally occurring at about 650-680 cm⁻¹ for the tellurite glasses of the invention).

The total cross-section σₜ of the spectrum of the tellurite glass is obtained by integrating the raw spectrum I over the frequency range 200 cm⁻¹ 1080 cm⁻¹. Then the relative total corrected cross-section σ_{corr} (i.e. the relative cross-section of the tellurite glass with respect to the cross-section of pure silica, σ_{Si}) is calculated by:
σ_{corr}=Fσₜ/σ_{Si} (3)

Thus, for instance, a value of σ_{corr} of 100 indicates that the total cross-section of the Raman emission spectrum of the tellurite glass is one hundred times greater than the total cross-section of the Raman emission of pure silica, in the same frequency range.

The Raman emission of a tellurite glass according to the invention shows a maximum in correspondence with at least one frequency shift. In the illustrative Raman spectrum of FIG. 2, three emission peaks can be observed, with respective maximums at about 450 cm⁻¹, about 660 cm⁻¹ and about 920 cm⁻¹. However, not only the maximum intensity of the peak is important for an effective Raman amplification, but also its relative broadness. Since the σ_{corr} is proportional to both the intensity of the Raman peaks and broadness of the bandwidth, it is apparent that, for a given peak intensity, a larger σ_{corr} results into a broader Raman emission spectrum. In addition, the same value σ_{corr} can be referred to a Raman emission showing either a very high or a relatively low peak intensity; in the first case, the bandwidth will be relatively narrow, although very intense; in the second case, the bandwidth will be comparatively broader. This second case, provided the intensity of the peak is sufficiently high, is generally preferred for amplification application. Therefore, the bandwidth broadening parameter σ_{corr}/Iₘₐₓ may give an indication of the Raman bandwidth broadening effect of a glass. Typically a value of about 1.00 or higher of this parameter is preferable.

A Raman amplifier according to the invention comprises an optical fiber which comprises a tellurite glass preferably having a maximum Raman gain Iₘₐₓ higher than 100 times the maximum Raman gain of pure silica, more preferably higher than about 120 times.

Furthermore, the total cross-section of the Raman spectrum σ_{corr} of said tellurite glass is preferably greater than 100 times, more preferably greater than 120 times than the total cross section of pure silica, in the frequency measurement range of from 200 cm⁻¹ to 1080 cm⁻¹. Much more preferably, said total cross-section of the Raman spectrum is about 150 times greater than the total cross section of pure silica, particularly when said tellurite glass comprises at least two different additional metal oxides.

As the bandwidth broadening parameter σ_{corr}/Iₘₐₓ of these glass compositions is generally close to 1.00, they result particularly suitable for manufacturing an optical fiber for Raman amplification.

According to a preferred aspect of the invention, a glass composition comprising a tellurium oxide and at least two different metal oxides is preferably used. In particular, said composition may comprise:
from 50% to 90% in mole percentage of TeO₂;
from 5% to 45% in mole percentage of a first metal oxide of an element selected from the group consisting of: Nb, W, Ti, Tl, Ta, and Mo;
from 5% to 30% in mole percentage of a second different metal oxide of an element selected from the group consisting of: Nb, W, Ti, Pb, Sb, In, Bi, Tl, Ta, Mo, Zr, Hf, Cd, Gd, La, Ba.

It has in fact been observed that the simultaneous presence of at least two different metal oxides results in glass composition with good optical and thermal properties.

As the glass composition is used in an optical fiber for Raman amplification, the presence of active rare earth elements (e.g. erbium) is not necessary. On the contrary as erbium has a strong detrimental effect on the attenuation, the present glass compositions are preferably substantially free of erbium. Substantially free, means that the amount of erbium in the glass composition is lower than 100 ppm.

Of course, a composition according to the invention may contain further metal oxides in addition to said first and second metal oxides, said further metal oxides being selected among those previously illustrated.

In addition, further metal oxides can be added to the metal composition, in order to tailor the core/clad properties of the optical fiber, such as refractive index, thermal expansion coefficient and viscosity. For instance, said oxide can be an oxide of a metal selected from the group consisting of Y, Sc, Al, Ga, Ge, P, Li, Na, K, Rb, Cs, Mg, Ca, Sr, Be, B, Zn. Typically, amounts of less than 30% in mole percentage of said oxides are added to the glass composition. For particular metal oxides which may negatively affect the Raman emission of the glass (e.g. lithium oxide), the molar amount is preferably lower than 5%. For example, a typical glass composition may contain:
from 50% to 90% in mole percentage of TeO₂;
from 5% to 30%, of a first oxide of an element selected from the group consisting of: Nb, W, Ti, Tl, Ta, and Mo;
from 5% to 30% of a second different oxide of an element selected from the group consisting of Nb, W, Ti, Pb, Tl, Ta, Mo, Bi and In
and optionally from 0.1% to 10% in mole percentage of a metal oxide where the metal is selected from the group consisting of Y, Sc, Al, Ga, Ge, P, Li, Na, K, Rb, Cs, Mg, Ca, Sr, Be, B, Zn.

As observed by the Applicant, the addition of at least a second metal oxide to a binary mixture of tellurite and of a first metal oxide, in order to obtain (at least) a ternary mixture of said oxides, may determine a broadening of the Raman emission bandwidth, thus rendering an optical fiber made from said glass composition particularly suitable for being used in a Raman amplifier.

In those instances where the addition of said second heavy metal oxide results in negligible variations of the emission bandwidth, the applicant has observed that said second oxide is nevertheless capable of increasing the thermal stability index (Tx-Tg) of the glass.

The thermal stability index is the temperature interval between a temperature Tx and the glass transition temperature (Tg). As used here, Tx represents the temperature at the onset of crystal formation, as determined by means of Differential Scanning Calorimetry (DSC) analysis, with a heating rate of 10° C./min. Any development of crystals in the glass can be detrimental because of attenuation caused by light scattering on the crystals, and should thus be avoided.

For drawing of fibers, the thermal stability index value of a glass should thus be as high as is compatible with other properties. A value of at least 100° C. is deemed necessary, while a value in excess of 120° C. is preferred. Such an index value, in view of the steepness of the viscosity curve for these glasses, is sufficient to permit the glass to be drawn into an optical fiber in a practical manner, for example, by redrawing “rod-in-tube” preforms.

Furthermore, if the thermal stability index is still higher, e.g. 150° C. or more, preferably 160° C. or more (e.g. about 175° C.), it is possible to produce preforms of relatively large diameter, e.g. up to about 2 cm or even more. As a matter of fact, the higher thermal stability index of the glass will allow the inner portion of the preform to reach the desired fiber drawing temperature, while avoiding the outer portion being subjected to detrimental high temperatures, close to the crystallization temperature.

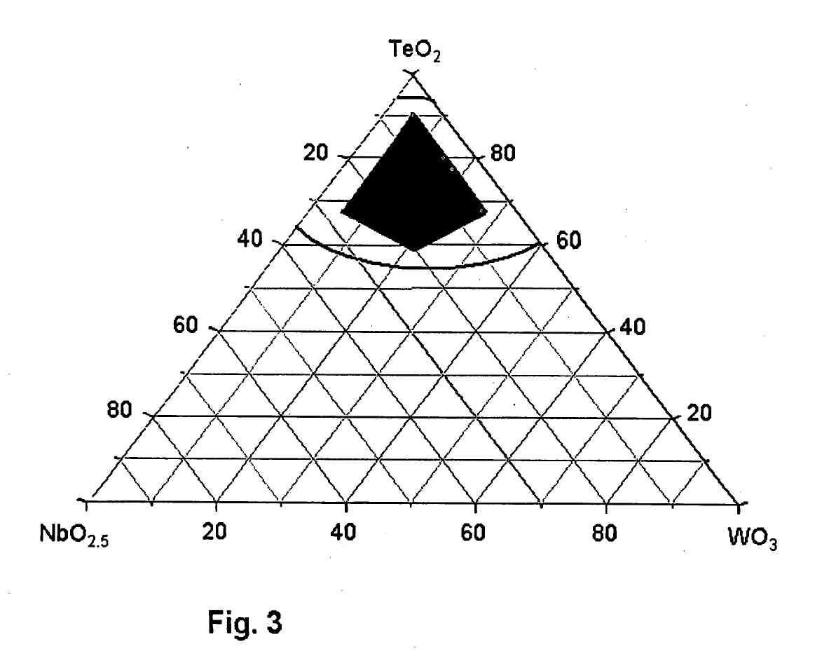

According to a preferred embodiment, a tellurite glass composition according to the invention comprises at least a tungsten oxide or a niobium oxide. As a matter of fact, the presence of each of these two oxides in a (at least) ternary tellurite glass composition allows to obtain compositions with particularly valuable properties in terms of Raman optical properties and of thermal stability. Examples of suitable ternary compositions are tellurite glasses comprising niobium and tungsten oxides (TNW glasses) and tellurite glasses comprising niobium and titanium oxides (TNT glasses). Particularly preferred are those tellurite glass compositions comprising both the above heavy metal oxides. It has in fact been observed that the combination of these two oxides into a tellurite based glass surprisingly results in a thermally very stable glass composition with good optical properties. Preferably, the amount of Nb oxide is from about 5% to about 30% in moles of the total composition. The amount of W oxide is preferably from about 5% to 30% in moles. FIG. 3 shows a ternary diagram of a TNW glass composition. The darkened region of said diagram indicates the preferred TNW compositions obtainable with the respective relative amounts of each of said oxides.

The glass compositions according to the invention can be prepared according to conventional melting techniques, which include admixing the raw materials, charging the mixture into a Pt/Au or Au crucible, melting the glass at a temperature between 750° C. and 950° C. under the atmosphere of O₂ and O₂/N₂, then casting the homogeneous melt into a preheated brass mould for forming a glass bulk or perform.

The cladding and over-cladding tube can be made by rotational-casting and drilling of a glass cylinder obtained as above described.

Tellurite glass fiber according to the invention, with a conventional core/cladding structure, can be fabricated, for instance, by well-known rod-in-tube methods, by collapsing said tube onto said rod, thus forming a preform which is drawn into an optical fiber.

A core preform and a cladding tube as above described can be used. The core glass is based for instance on TeO₂—NbO_{2.5}—WO₃ glasses while the cladding is made from the same material added with and amount of less than about 5 mol % (e.g. about 3%) of a further metal oxide, e.g. Al₂O₃ or La₂O₃, for lowering the refractive index. A fiber loss around 1 dB/m or less can be obtained by employing commercially raw materials with high purity of (e.g. 99,999% or higher).

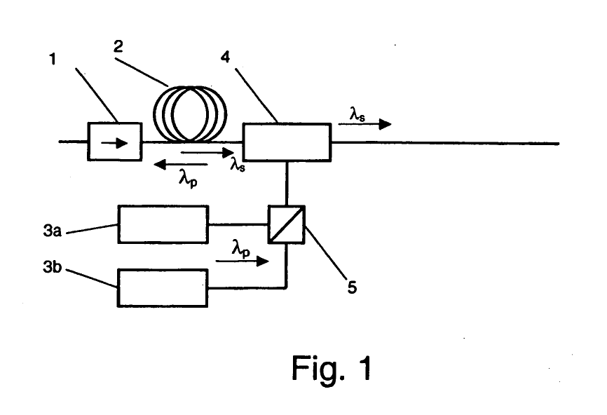

An optical fiber according to the invention can be used for Raman amplification, for instance in Raman amplifier as illustrated in FIG. 1.

FIG. 1 shows an embodiment of a Raman amplifier according to the invention. The Raman amplifier comprises an optical fiber 2 according to the invention and at least one pump laser 3a, optically connected to one end of the fiber 2, for example through a WDM coupler 4.

In the exemplary preferred embodiment shown in FIG. 1 two pump lasers 3a, 3b are provided, adapted for emitting polarized pump radiation at a wavelength λₚ and having substantially the same power emission. The two pump radiations are coupled together through a polarization beam splitter 5 so that orthogonal polarization states are sent downstream of the polarization beam splitter 5. The polarization beam splitter 5 is connected to one end of the WDM coupler 4. Another end of the WDM coupler 4 is adapted to receive an optical signal at a wavelength λ to be amplified. An optical isolator 1 is preferably provided before optical fiber 2. A third end of the WDM coupler 4 is connected to the fiber 2. The optical connection of WDM coupler 4 to the fiber 2 may comprise a corrective optics, for instance focusing lenses, in order to optimize the coupling of the optical radiation in the fiber 2. In the configuration shown in FIG. 1, the optical signal and the pump radiation are counter-propagating in the fiber 2. An alternative embodiment may provide co-propagation between optical signal and pump radiation. A further alternative embodiment may provide both co- and counter-propagating pump radiation with respect to the optical signal. In other embodiments, not shown, plural pump sources having different emission wavelengths may be provided. The Raman amplifier according to the invention may be a single stage amplifier, or a multi-stage amplifier, or may be a part of a multi-stage amplifier. Further, the Raman amplifier according to the invention may be combined with other types of amplifiers, such as for example erbium doped fiber amplifiers or semiconductor amplifiers.

The optical signal may have a wavelength λₛ comprised between about 1460 nm and 1650 nm, preferably between about 1525 nm and 1625 nm. The radiation emitted by the pump lasers 3a, 3b is related to the signal radiation wavelengths: in order to have Raman amplification, the wavelength of the pump lasers should be shifted with respect to the signal radiation wavelengths in a lower wavelength region of the spectrum, such shift being equal to the Raman shift (see G. P. Agrawal, “Nonlinear Fiber Optics”, Academic Press Inc. (1995), pag. 317-319) of the material comprised in the core of the fiber 2 for at least one signal radiation wavelength.

The Raman amplifier according to the invention may be part of an optical transmission system, advantageously a WDM transmission system, comprising a transmitting station, a receiving station and an optical line connecting said transmitting station and said receiving station. The transmitting station comprises at least one transmitter adapted to emit the optical signal carrying an information. For a WDM transmission, the transmitting station comprises a plurality of transmitters adapted to emit a respective plurality of optical channels, each having a respective wavelength and a multiplexing unit to combine the optical channels into a common output. In this case, the optical signal is a WDM optical signal, comprising different optical channels. The receiving station comprises at least one receiver adapted to receive said optical signal and discriminate said information. For a WDM transmission, the receiving station comprises a plurality of receivers adapted to receive the WDM optical signal and discriminate the information carried by each optical channel received and a splitting unit (preferably wavelength selective, such as a demultiplexer) to deliver to the receivers the WDM optical signals reaching the receiving unit. The optical line comprises at least one transmission optical fiber. At least one amplifier, comprising at least one Raman amplifier according to the invention, is provided along the optical line in order to counteract attenuation introduced on the optical signal by at least a portion of said transmission optical fiber or fibers. Other sources of attenuation can be connectors, couplers/splitters and various devices, such as for example modulators, switches, add-drop multiplexers and so on, disposed along the optical line. The optical transmission system comprising at least one Raman amplifier according to the invention can be any kind of optical transmission system, such as for example a terrestrial transmission system, e.g. for long haul, metropolitan or access networks, or a submarine transmission system. The transmission system may also comprise other types of amplifiers, such as for example erbium doped fiber amplifiers or semiconductor amplifiers, in combination with at least one Raman amplifier according to the invention.

The following examples are provided for better illustrating the invention.

### EXAMPLES

### Example 1

Preparation of Glass Compositions

Glass compositions have been prepared by conventional melting techniques, by admixing the raw oxide materials in the prescribed molar amounts and charging the mixture in a Pt/Au crucible. A batch of about 50 g of each composition was melted in an electric furnace at temperature between 750° C. and 950° C. for 2 hours under the atmosphere of O₂/N₂. Then the homogeneous melt was casted into a preheated brass mould for forming a glass bulk or perform. The glass was annealed below Tg for 4 hours.

The following table 1 shows the compositions which have been prepared, where the amount of each oxide is expressed as molar percentage over the total composition.

TABLE 1
Glass compositions

| | TeO₂ | NbO_{2.5} | WO₃ | TiO₂ |
|---|---|---|---|---|
| TN10 | 90 | 10 | | |
| TN20 | 80 | 20 | | |
| TN30 | 70 | 30 | | |
| TW10 | 90 | | 10 | |
| TW20 | 80 | | 20 | |
| TW30 | 70 | | 30 | |
| TT5 | 95 | | | 5 |
| TT10 | 90 | | | 10 |
| TT15 | 85 | | | 15 |
| TNW | 72 | 18 | 10 | |
| TNT | 72 | 18 | | 10 |

A comparative glass composition (TZLB) comprising TeO₂, ZnO, LiO₂ and Bi₂O₃ in the respective percentage molar amount of 78%, 5%, 12% and 5% has also been prepared, in accordance with the compositions disclosed by the above cited JP patent application Publication No. 2001-109026.

### Example 2

Thermal Stability of Glass Compositions

The above glass compositions have been subjected to DSC analysis, in order to determine the Tg and Tx of each composition, and thus the respective thermal stability index Tx-Tg.

For each glass composition, three bulk glass samples of around 20 mg were subjected to a DSC characterisation at a heating rate of 10° C./min in N₂ gas atmosphere. The measurement was performed using a DSC series Q10 apparatus (TA Instruments, U.S.A.).

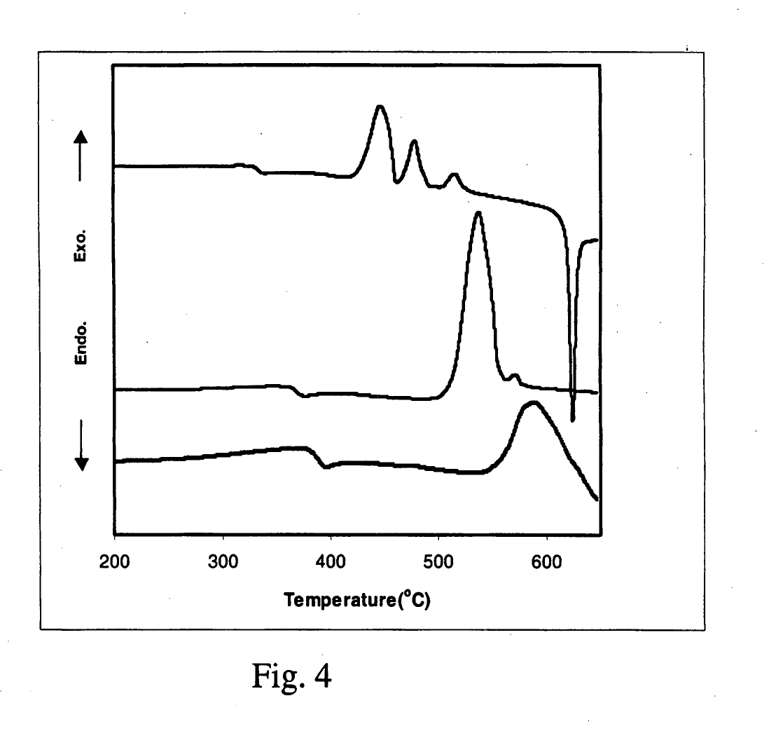

FIG. 4 shows an example of a DSC plot of the following glass compositions: TNW, TN20 and TW10. The respective Tg and Tx values derivable from said plot, corresponding to the endothermic and to the (first) exothermic peak, respectively, are reported in the following table 2, together with the Tg and Tx values of the other glass compositions manufactured according to example 1. Table 2 further shows the relative Tx-Tg thermal stability index of said glass compositions.

TABLE 2
Thermal stability

| | Tg(° C.) | Tx (° C.) | (Tₓ − T_{g}) |
|---|---|---|---|
| TN10 | 326 | 432 | 106 |
| TN20 | 362 | 515 | 153 |
| TN30 | 398 | 523 | 125 |
| TW10 | 329 | 428 | 99 |
| TW20 | 349 | 497 | 148 |
| TW30 | 368 | 521 | 153 |
| TT5 | 321 | 393 | 72 |
| TT10 | 341 | 439 | 98 |
| TT15 | 364 | 450 | 86 |
| TNW | 380 | 555 | 175 |
| TNT | 405 | 535 | 130 |

From the results of table 2, it may be appreciated the positive influence of the second heavy metal oxide on the thermal stability of the glass composition. In particular, the ternary composition TNW shows an increased thermal stability index with respect to the corresponding binary mixtures TN and TW. The TNT ternary glass composition also shows an increased thermal stability with respect to the binary TT compositions and a generally comparable thermal stability with respect to the binary TN compositions.

### Example 3

Optical Properties of Glass Compositions

Raman measurements have been performed on polished thin slabs of the above glass compositions of about 1 mm thickness.

A confocal microscope optics has been used in order to focus well inside the sample, and in order to collect the scattered light from the same region. For this purpose, the same microscope optics were used both for the incident laser beam and for the collection of the Raman scattered light. The measurements have therefore been carried out in a backscattering geometry.

The Raman scattered light was analysed with a spectrometer and detected by a cooled CCD detector.

Two different linearly polarized laser sources were used, a frequency doubled Nd:YAG laser operating at 532 nm. As the green light of the 532 nm pump is relatively close to the absorption gap of the tellurite glasses, resonant Raman contribution could appear in the measured Raman spectrum. In order to check these contributions, the measured differential Raman scattering cross-section have been compared by using the green pump (at 532 nm) and He—Ne laser operating at 633 nm red pump (at 633 nm). Taking into account the λₚᵤₘₚ⁻⁴ dependence of the Raman scattering cross-section, and always normalizing the measurement with respect to the silica reference, the two spectra were always overlapping to within a few percent. This indicates absence of any resonance contributions when the green pump is used.

The system for the Raman measurements was composed as follows:
an Olympus (JP) model BX40 confocal microscope with a 50× (aperture 0.45) objective;
a Jobin-Yvon (France) T64000 triple grating spectrometer with three holographic gratings with 1800 lines per mm to disperse and recombine light, achieving a spectral resolution of about 3 cm−1;
a I.S.A. ASTROMED liquid nitrogen cooled camera detection system, which relies on a frontally illuminated Charge Coupled Device.

The excitation source is provided by the 532 nm line of a frequency doubled Nd:YAG Coherent DPSS 532 laser, or by a standard He—Ne laser for 633 nm.

In order to make a quantitative analysis, the Raman spectrum of each glass composition obtained with the above pump at 532 nm has been corrected as previously explained, in order to obtain the respective values of σ_{corr} and I_{corr}.

In order to effectively evaluate both the maximum intensity and the broadness of the emission spectrum of each glass composition the previously discussed broadening parameter (σ_{corr}/Iₘₐₓ) has been used as an indicator of the bandwidth broadening of a glass.

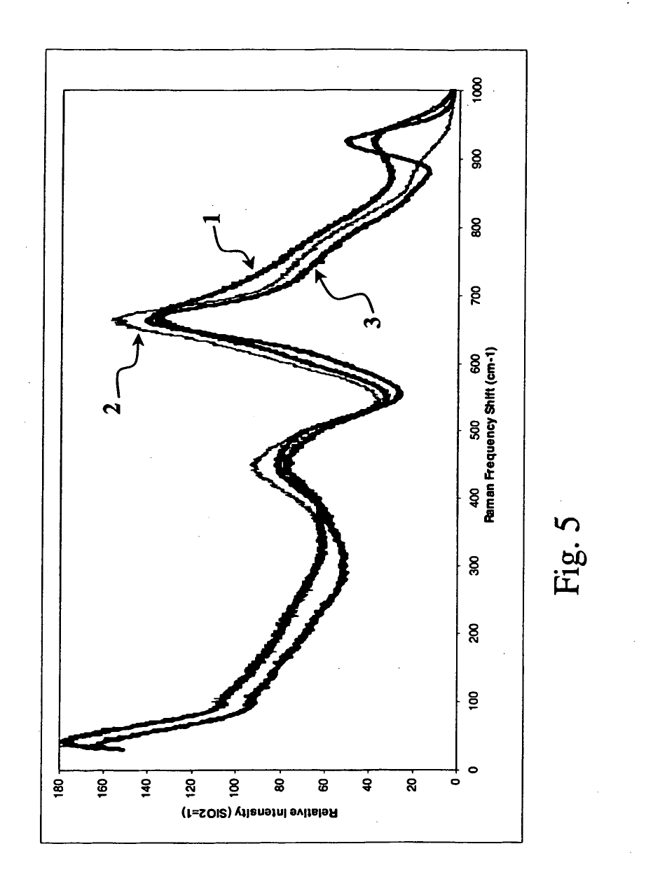

FIG. 5 shows the overlapped Raman spectra of the following glass compositions: TNW (line 1), TN20 (line 2) and TW10 (line 3).

The following table 3 shows:
the corrected peak Raman intensity (I_{corr});
the corrected total differential Raman cross-section (σ_{corr}) relative to SiO₂ glass; and
the broadening parameter (σ_{corr}/Iₘₐₓ) for the glass compositions of Example 1.

In the I_{corr} column, the higher value given for each glass composition corresponds to the respective maximum gain Iₘₐₓ.

Table 3 also contains the respective values of the reference silica sample.

TABLE 3
Optical properties of glass compositions

| Glass | n | Correction | Δν peak | | | |
|---|---|---|---|---|---|---|
| system | (532 nm) | factor F | (cm⁻¹) | I_{corr} | σ_{corr} | σ_{corr}/Iₘₐₓ |
| Silica | 1.4607 | 1 | 440 | 1 | 1 | 1 |
| TN10 | 2.2135 | 2.91 | 451 | 87 | | |
| | | | 663 | 152 | 137 | 0.90 |
| TN20 | 2.2030 | 2.87 | 451 | 89 | | |
| | | | 663 | 155 | 157 | 1.01 |
| TN30 | 2.2163 | 2.92 | 450 | 82 | | |
| | | | 664 | 141 | 157 | 1.11 |
| TW10 | 2.2113 | 2.9 | 460 | 82 | | |
| | | | 663 | 142 | 143 | 1.01 |
| | | | 925 | 51 | | |
| TW20 | 2.2153 | 2.92 | 468 | 79 | | |
| | | | 675 | 137 | 163 | 1.19 |
| | | | 925 | 85 | | |
| TW30 | 2.2186 | 2.93 | 473 | 71 | | |
| | | | 684 | 137 | 179 | 1.31 |
| | | | 928 | 111 | | |
| TT5 | 2.211 | 2.90 | 452 | 96 | | |
| | | | 657 | 156 | 132 | 0.85 |
| TT10 | 2.2211 | 2.94 | 452 | 102 | | |
| | | | 657 | 146 | 140 | 0.96 |
| TT15 | 2.2256 | 2.95 | 453 | 110 | | |
| | | | 655 | 140 | 148 | 1.06 |
| TNW | 2.2116 | 2.90 | 455 | 77 | | |
| | | | 670 | 137 | 161 | 1.18 |
| | | | 922 | 39 | | |
| TNT | 2.2233 | 2.94 | 450 | 97 | | |
| | | | 654 | 138 | 162 | 1.17 |
| TZLB | 2.1 | 2.52 | 435 | 49 | | |
| | | | 670 | 69 | | |
| | | | 751 | 74 | 81 | 1.09 |

As shown by the above table, both the maximum peak intensity and the total cross-sectional area of the Raman spectrum of tellurite glasses according to the invention are higher than 100 and comparatively higher with respect to the same parameters of the known TZLB glass compositions.

In particular, as shown by the above table 3 and by FIG. 5, the ternary TNW composition combines the advantages of a high peak intensity and of a significant broadening which are particularly preferred for Raman applications. As mentioned before, this ternary glass also shows very good thermal stability. While this composition shows a slight decrease of the peak intensities as compared to the parent binary compositions TN20 and TW10, its corrected total differential Raman cross-section σ_{corr} is larger. By comparing the broadening parameter σ_{corr}/Iₘₐₓ of the TNW composition with those of its parent TN20 and TW10 compositions, those skilled in the art may appreciate the increased bandwidth broadening obtainable with said glass composition.

The broadening effect of a ternary mixture can also be appreciated for the TNT ternary system. This composition shows in fact a σ_{corr}/Iₘₐₓ of 1.17 (comparable to the TNW value), much higher than the σ_{corr}/Iₘₐₓ values of the corresponding TT10 and TW10 parent binary compositions.

What is claimed is:

1-28. (canceled)

29. A Raman amplifier comprising at least one optical fiber and at least one pump laser, optically coupled to said optical fiber, said pump laser being adapted for emitting a pump radiation at a wavelength λₚ, wherein said optical fiber comprises a tellurite glass suitable for enhancing Raman effect, said glass comprising:
from 50% to 90% in mole percentage of TeO₂;
from 5% to 45% in mole percentage of a first metal oxide of an element selected from the group of Nb, W, Ti, Tl, Ta, and Mo; and
from 5% to 30% in mole percentage of a second different metal oxide of an element selected from the group of Nb, W, Ti, Pb, Sb, In, Bi, Tl, Ta, Mo, Zr, Hf, Cd, Gd, La, and Ba.

30. The Raman amplifier according to claim 29, wherein the mole percentage of TeO₂ in said glass is from 65% to 85%.

31. The Raman amplifier according to claim 29, wherein the mole percentage of said first metal oxide is from 5% to 30%.

32. The Raman amplifier according to claim 29, wherein the mole percentage of said first metal oxide is from 10% to 25%.

33. The Raman amplifier according to claim 29, wherein the mole percentage of said second metal oxide is from 5% to 20%.

34. The Raman amplifier according to claim 29, wherein said tellurite glass further comprises an oxide of a metal selected from the group of Y, Sc, Al, Ga, Ge, P, Li, Na, K, Rb, Cs, Mg, Ca, Sr, Be, B, and Zn.

35. The Raman amplifier according to claim 29, wherein said first oxide is an oxide of an element selected from the group of Nb, W and Ti.

36. The Raman amplifier according to claim 29, wherein said second oxide is an oxide of an element selected from the group of Nb, W and Ti.

37. The Raman amplifier according to claim 35, wherein said second oxide is an oxide of an element selected from the group of Nb, W and Ti.

38. The Raman amplifier according to claim 29, wherein said tellurite glass comprises from 50% to 90% in mole percentage of TeO₂, from 5% to 30% in mole percentage of niobium oxide and from 5% to 30% in mole percentage of tungsten oxide.

39. A Raman amplifier comprising at least one optical fiber and at least one pump laser, optically coupled to said optical fiber, said pump laser being adapted for emitting a pump radiation at a wavelength λₚ, said optical fiber comprising a tellurite glass suitable for enhancing Raman effect, said glass comprising:
from 55% to 95% in mole percentage of TeO₂; and
from 5% to 45% in mole percentage of a metal oxide of an element selected from the group of Nb, Ti, Tl, Ta, and Mo.

40. The Raman amplifier according to claim 39, wherein said tellurite glass comprises from 65% to 95% in mole percentage of TeO₂.

41. The Raman amplifier according to claim 39, wherein said tellurite glass comprises from 5% to 35% in mole percentage of said metal oxide.

42. An optical telecommunication link including an optical fiber path for transmitting an optical signal and at least a Raman amplifier optically coupled along said optical fiber path, said Raman amplifier comprising at least one optical fiber and at least one pump laser, optically coupled to said optical fiber, said pump laser being adapted for emitting a pump radiation at a wavelength λₚ, wherein said optical fiber comprises a tellurite glass suitable for enhancing Raman effect, said glass comprising:
from 50% to 90% in mole percentage of TeO₂;
from 5% to 45% in mole percentage of a first metal oxide of an element selected from the group of Nb, W, Ti, Tl, Ta, and Mo; and
from 5% to 30% in mole percentage of a second different metal oxide of an element selected from the group of Nb, W, Ti, Pb, Sb, In, Bi, Tl, Ta, Mo, Zr, Hf, Cd, Gd, La, and Ba.

43. An optical telecommunication link including an optical fiber path for transmitting an optical signal and at least a Raman amplifier optically coupled along said optical fiber path, said Raman amplifier comprising at least one optical fiber and at least one pump laser, optically coupled to said optical fiber, said pump laser being adapted for emitting a pump radiation at a wavelength λₚ, said optical fiber comprising a tellurite glass suitable for enhancing Raman effect, said glass comprising:
from 55% to 95% in mole percentage of TeO₂; and
from 5% to 45% in mole percentage of metal oxide of an element selected from the group of Nb, Ti, Tl, Ta, and Mo.

44. An optical fiber for Raman amplification comprising a glass composition which comprises:
from 50% to 90% in mole percentage of TeO₂;
from 5% to 45% in mole percentage of a first metal oxide of an element selected from the group of Nb, W, Ti, Tl, Ta, and Mo; and
from 5% to 30% in mole percentage of a second different metal oxide of an element selected from the group of Nb, W, Ti, Pb, Sb, In, Bi, Tl, Ta, Mo, Zr, Hf, Cd, Gd, La, and Ba;
said composition being substantially free of erbium.

45. The optical fiber according to claim 44, wherein said first oxide is an oxide of an element selected from the group of Nb, W and Ti.

46. The optical fiber according to claim 44, wherein said second oxide is an oxide of an element selected from the group of Nb, W and Ti.

47. The optical fiber according to claim 44, wherein said glass comprises from 50% to 90% in mole percentage of TeO₂, from 5% to 30% in mole percentage of niobium oxide and from 5% to 30% in mole percentage of tungsten oxide.

48. An optical fiber for Raman amplification comprising a glass composition which comprises:
from 55% to 95% in mole percentage of TeO₂; and
from 5% to 45% in mole percentage of a metal oxide of an element selected from the group of Nb, Ti, Tl, Ta, and Mo;
said composition being substantially free of erbium.

49. The optical fiber according to claim 44 or 48 wherein said glass composition has a thermal stability index, Tx-Tg, higher than 125° C.

50. The optical fiber according to claim 49, wherein said thermal stability index, Tx-Tg, is higher than 150° C.

51. The optical fiber according to claim 49, wherein said thermal stability index, Tx-Tg, is higher than 160° C.

52. The optical fiber according to claim 44 or 48, wherein said glass composition shows a maximum Raman gain higher than 100 times with respect to pure silica glass.

53. The optical fiber according to claim 52, wherein said glass composition shows a maximum Raman gain higher than 120 times with respect to pure silica glass.

54. The optical fiber according to claim 44 or 48, wherein said glass composition has a total cross-section of the Raman emission spectrum in the frequency shift range of 200 cm⁻¹ to 1080 cm⁻¹, at least 100 times greater with respect to the total cross-section of the Raman emission of pure silica in the same frequency shift range.

55. The optical fiber according to claim 54, wherein said total cross-section of the Raman emission spectrum of said glass composition is at least 120 times greater with respect to the total cross-section of the Raman emission of pure silica in the same frequency shift range.

56. The optical fiber according claim 54, wherein said total cross-section of the Raman emission spectrum of said glass composition is at least 150 times greater with respect to the total cross-section of the Raman emission of pure silica in the same frequency shift range.

57. An optical fiber comprising a core portion and a cladding portion, wherein at least said core portion is made from a tellurite glass which comprises:
from 50% to 90% in mole percentage of TeO₂;
from 5% to 45% in mole percentage of a first metal oxide of an element selected from the group of Nb, W, Ti, Tl, Ta, and Mo; and
from 5% to 30% in mole percentage of a second different metal oxide of an element selected from the group of Nb, W, Ti, Pb, Sb, In, Bi, Tl, Ta, Mo, Zr, Hf, Cd, Gd, La, and Ba;
said composition being substantially free of erbium.

58. An optical fiber comprising a core portion and a cladding portion, wherein at least said core portion is made from a tellurite glass which comprises:
from 55% to 95% in mole percentage of TeO₂; and
from 5% to 45% in mole percentage of a metal oxide of an element selected from the group of Nb, Ti, Tl, Ta, and Mo;
said composition being substantially free of erbium.

59. A method for increasing at least one of the parameters selected among Raman bandwidth broadening and thermal stability of a binary glass composition including tellurium oxide and a first metal oxide of an element selected among Nb, W, Ti, Tl, Ta, and Mo which comprises:
preparing a ternary glass composition comprising said tellurium oxide, said first metal oxide and a predetermined amount of a second different metal oxide of an element selected among Nb, W, Ti, Pb, Sb, In, Bi, Tl, Ta, Mo, Zr, Hf, Cd, Gd, La, and Ba.
